(19) United States
(12) Patent Application Publication
(10) Pub. No.: US 2005/0213345 A1
(43) Pub. Date: Sep. 29, 2005

(54) Light source device for illumination

(75) Inventor: Masayuki Inamoto, Saitama-shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/087,598

(22) Filed: Mar. 24, 2005

(30) Foreign Application Priority Data
Mar. 24, 2004 (JP) 2004-086301

(51) Int. Cl. F21V 5/00; F21V 7/04

(52) U.S. Cl. 362/612

(57) ABSTRACT

A light source device for illumination is equipped with plural light emitting arranged in a concave shape so that respective main illumination axes thereof cross one another substantially at one point, and a light guide which has a light incidence face disposed in the neighborhood of the cross point of the main illumination axes and guides illumination light emitted from the plural light emitting diodes and incident from the light incident face to an illumination optical system for image projection.

This application is based on Japanese Patent application JP 2004-086301, filed Mar. 24, 2004, the entire content of which is hereby incorporated by reference. This claim for priority benefit is being filed concurrently with the filing of this application.

### BACKGROUND OF THE INVENTION

1. Technical Field of the Invention

The present invention relates to a light source device for illumination which is used for, for example, a projector or the like.

2. Description of the Related Art

A projector using a liquid crystal panel or DMD (digital micro-mirror device) has been known as a projector for projecting light supplied with information such as an image or the like to a screen to display the image on the screen. According to a liquid crystal projector using a liquid crystal panel, illumination light irradiated to the liquid crystal panel is transmitted through the liquid crystal panel or illumination light irradiated to the liquid crystal panel is reflected by the liquid crystal panel, whereby image information displayed on the liquid crystal panel is projected to the screen. The image information displayed on the liquid crystal panel is displayed on the screen while being enlarged.

The liquid crystal projector is equipped with an illumination light source device for illuminating light to the liquid crystal panel, and an illumination optical system for uniformly irradiating illumination light from the illumination light source device onto the liquid crystal panel is provided in front of the illumination light source device. The illumination optical system contains a lens, a polarization converting element, etc., and the illumination light irradiated from the illumination light source device is irradiated through the illumination optical system to the liquid crystal panel. It is preferable that the liquid crystal panel is illuminated with bright and uniform light, and thus it is desired that the illumination light irradiated from the illumination light source device has high brightness and the light flux thereof is uniform. Accordingly, it has been general to use as the illumination light source device a high-luminance discharge lamp which can light having brightness (high luminance) needed to project an image on the liquid crystal panel such as an ultra-high pressure mercury lamp, a metal halide lamp, a xenon lamp or the like.

The high-luminance discharge lamp is heated, and thus it is necessary to provided a large-scale cooling device for cooling the lamp. However, when the cooling device is provided, there is a problem that the illumination light source device must be designed in a large size and further the manufacturing cost of the projector is increased. Furthermore, it has been required to reduce the cost when the projector is used, for example, to reduce the power to be consumed to irradiate high-brightness light and further to lengthen the period for which the high-luminance discharge lamp can be used.

Therefore, it has been recently considered that a light emitting diode (hereinafter referred to as “LED”) is used as a light source of an illumination light source device in place of the ultra-high discharge lamp. LED has advantages that it is more compact in size, lighter in weight, smaller in power consumption and longer in lifetime, it can be driven with a low voltage and it has a high response speed when it is subjected to turn-on control as compared with the ultra-high discharge lamp described above. However, illumination light emitted from LED is diffused over a broad range, and thus there have been proposed various methods for efficiently condensing diffused light of LED, for example, JP-A-2003-186110 has proposed that illumination light emitted from LED is focused by a lens, JP-A-2003-177353 and JP-A-2003-302702 have proposed that the irradiation direction of illumination light emitted from LED is varied to a predetermined direction, and JP-A-2003-347595 has proposed that plural LEDs are arranged in a cylindrical form, illumination light irradiated from LEDs is reflected in a predetermined direction by a conical reflecting element.

However, according to the methods disclosed in JP-A-2003-186110, JP-A-2003-177353, and JP-A-2003-302702, since the illumination light irradiated from LEDs are condensed at the front side, the illumination light irradiated to the front side of the LEDs can be condensed, however, the light of the LEDs which is diffused over a broad range cannot be sufficiently condensed. Therefore, there is a problem that light having sufficient intensity needed to irradiate light having high brightness cannot be achieved. Furthermore, according to the method disclosed in JP-A-2003-347595, only the irradiation direction of the illumination light irradiated from LEDs is merely varied, and there is a risk that it may be impossible to achieve light having sufficient intensity needed to irradiate light having high brightness.

### SUMMARY OF THE INVENTION

The present invention has an object to provide an illumination light source device which can irradiate illumination light having high brightness although light emitting diodes are used.

A light source device for illumination according to the present invention is equipped with plural light emitting arranged in a concave shape so that respective main illumination axes thereof cross one another substantially at one point, and a light guide which has a light incidence face disposed in the neighborhood of the cross point of the main illumination axes and guides illumination light emitted from the plural light emitting diodes and incident from the light incident face to an illumination optical system for image projection.

It is preferable that a condensing lens is disposed on each of the main illumination axes of the plural light emitting diodes, and condenses illumination light from each light emitting diode to make the illumination light incident to the light incident face of the light guide.

It is preferable that the light guide comprises a rod integrator for guiding the respective illumination lights incident from the light incidence face while mixing the respective illumination lights by internal reflection.

It is preferable that the plural light emitting diodes contain at least two types of light emitting diodes which emit different color lights, respectively.

It is preferable that the plural light emitting diodes are white light emitting diodes for irradiating white light.

According to the present invention, the illumination light source device is equipped with plural light emitting arranged in a concave shape so that respective main illumination axes thereof cross one another substantially at one point, and the light guide which has the light incidence face disposed in the neighborhood of the cross point of the main illumination axes and guides illumination light emitted from the plural light emitting diodes and incident from the light incident face to the illumination optical system for image projection. Therefore, the illumination light irradiated from the plural light emitting diodes can be efficiently condensed, and light having high brightness and an in-plane uniform brightness distribution can be irradiated in spite of use of the light emitting diodes.

Furthermore, the condensing lens is disposed on each of the main illumination axes of the plural light emitting diodes, and condenses illumination light from each light emitting diode to make the illumination light incident to the light incident face of the light guide. Therefore, the illumination light irradiated from the light emitting diodes can be prevented from being diffused, and the light can be made efficiently incident to the incidence face of the guide member.

The light guide comprises the rod integrator for guiding the respective illumination lights incident from the light incidence face to the light emission face while mixing the respective illumination lights by internal reflection. Therefore, light having substantially uniform intensity can be emitted, and condensed light from the light emitting diodes can be efficiently used.

Furthermore, the plural light emitting diodes are the white light emitting diodes for irradiating white light. Therefore, a related art high-brightness discharge lamp can be replaced by light emitting diodes, and the related art parts other than the high-brightness discharge lamp can be used, so that the manufacturing cost can be reduced.

The plural light emitting diodes contain at least two types of light emitting diodes which emit different color lights, respectively. Therefore, for example when the illumination light source device of the present invention is provided to a projector, the color tone of the light source can be corrected, and a projector having higher color reproduction performance can be manufactured.

### BRIEF DESCRIPTION OF THE DRAWINGS

FIG. 1 is a diagram showing the construction of one embodiment of a projector used for the invention.

FIG. 2 is a perspective view showing one embodiment of the outlook of an illumination light source device of the invention.

FIG. 3 is a cross-sectional view showing one embodiment of a light source of the invention.

FIG. 4 is a diagram showing an irradiation direction of light irradiated from the white LEDs.

FIG. 5 is a diagram showing the intensity of light irradiated from the white LEDs.

### DETAILED DESCRIPTION OF THE INVENTION

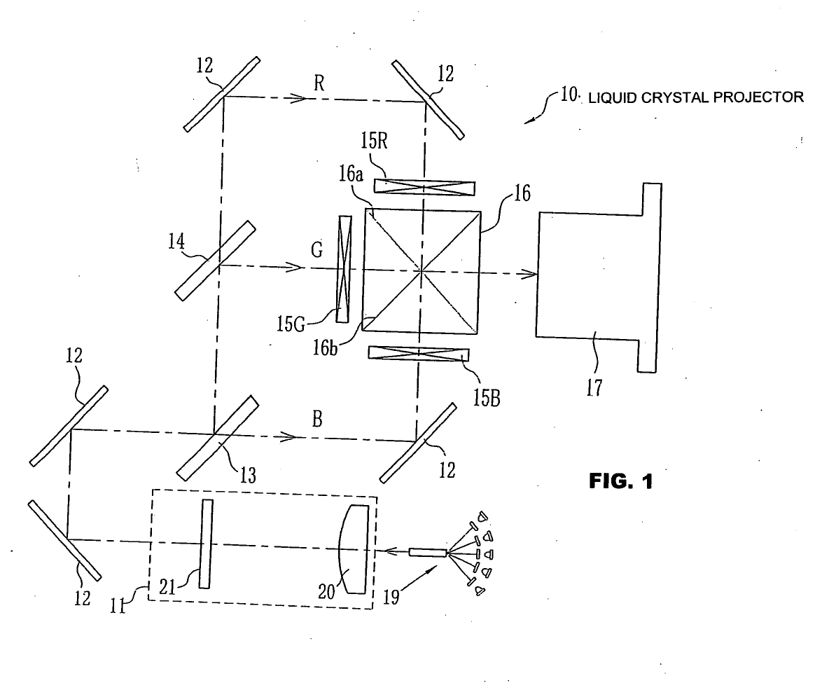

In FIG. 1, a liquid crystal projector 10 is equipped with an illumination optical system 11 for image projection, a mirror 12 for varying an irradiation direction of irradiated illumination light, dichroic mirrors 13, 14, three transmission type liquid crystal panels (image display elements) 15R, 15G, 15B, a cross dichroic prism 16, a projection lens 17, a screen 18 and an illumination light source device 19 of the present invention.

The illumination optical system 11 is equipped with a lens 20 and a polarization converting element 21. White light containing red light (R light), green light (G light) and blue light (B light) are irradiated from the illumination light source device 19 to the downstream side thereof. The illumination light irradiated from the illumination light source device 19 is incident to the lens 20. The illumination light incident to the lens 20 is collimated and then irradiated to the downstream side of the lens 20. The polarization converting element 21 is disposed at the downstream side of the lens 20. The polarization converting element 21 transmits illumination light irradiated from the illumination light source device 19 therethrough to convert the illumination light to R light, G light and B light having no specific polarization plane to S-polarized light. Each color illumination light transmitted through the polarization converting element 21 is reflected by the mirror 12 and then incident to the dichroic mirror 13.

The dichroic mirror 13 transmits B light contained in white light and reflects R light and G light to separate the B light. The B light thus separated is reflected by the mirror 12 and incident to the liquid crystal panel 15B. The R light and the G light reflected by the diachronic mirror 13 are incident to the diachronic mirror 14. The diachronic mirror 14 transmits the R light therethrough and reflects the G light to separate the R light and the G light from each other. The R light transmitted through the dichroic mirror 14 is reflected from the mirror 12, and incident to the liquid crystal panel 15R. The G light reflected by the dichroic mirror 14 is incident to the liquid crystal panel 15G.

In the liquid crystal panels 15R, 15G, 15B, the R light, the G light and the B light incident thereto are supplied with image information. The light flux of the R light, the G light and the B light transmitted through the liquid crystal panels 15R, 15G, 15B is incident to the cross dichroic prism 16. The cross dichroic prism 16 comprises a combination of four rectangular prisms. The cross dichroic prism 16 has two kinds of dichroic faces of a R light reflection face 16a for reflecting R light and a B light reflection face 16b for reflecting B light, and the orthogonal prisms thereof are arranged so that the R light reflection face 16a and the B light reflection face 16B are orthogonal to each other.

When the R light transmitted through the liquid crystal panel 15R is reflected by the R light reflection face 16a, the irradiation direction of the R light is varied so as to be orthogonal to the transmission direction of the R light through the liquid crystal panel 15R so that the reflected R light is directed to the projection lens 17, and thus the R light is incident to the projection lens 17. The G light transmitted through the liquid crystal panel 15G is transmitted through the R light reflection face 16a and the B light reflection face 16b, straightly travel and then are incident to the projection lens 17. When the B light transmitted through the liquid crystal panel 15B is reflected by the B light reflection face 16b, the irradiation direction of the B light is varied so as to be orthogonal to the transmission direction of the B light through the liquid crystal panel 15B so that the reflected B light is directed to the projection lens 17, and thus the B light is incident to the projection lens 17. The projection lens 17 projects the light flux of the respective color light combined by the cross dichroic prism 16 while enlarging each color light flux, and focuses them onto the screen 18 (not shown), whereby the image information is displayed on the screen 18.

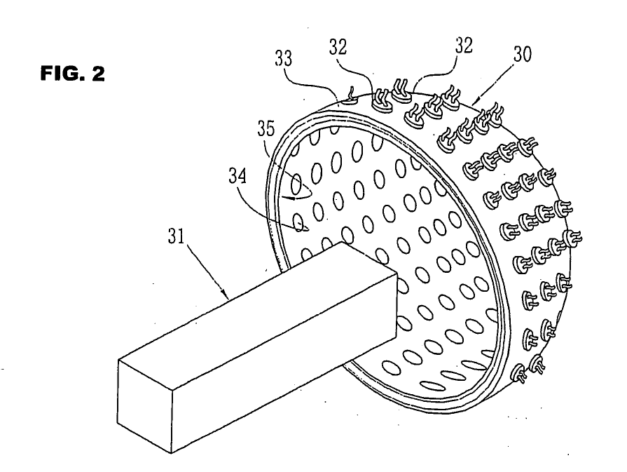

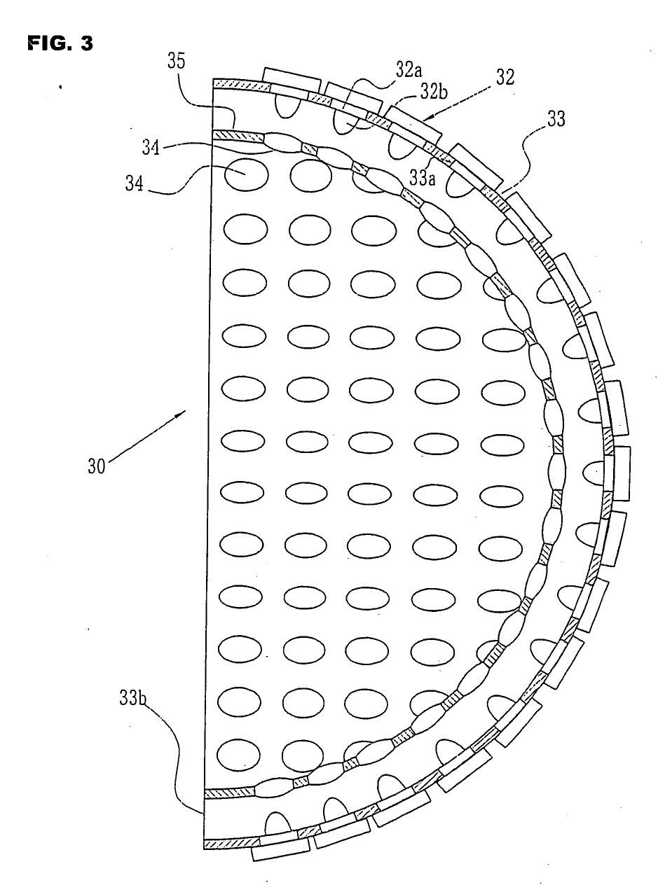

As shown in FIGS. 2 and 3, the illumination light source device 19 is equipped with a light source 30, and a rod integrator (light guide) 31.

The light source 30 comprises plural white LEDs (light emitting diodes) 32 for emitting white light, a base member 33 to which the white LEDs 32 are mounted, and a lens array 35 having plural condensing lens 34 for condensing light emitted from the white LEDs.

Each of the white LEDs 32 has a fixing portion 32a to be fixed to the base member 33 and an irradiation portion 32b for irradiating light. The base member 33 is designed in a semispherical shape having a hollow portion therein, and plural holes 33a are formed in the outer peripheral surface of the base member 33 so as to be spaced from one another at predetermined intervals. The fixing portion 32a is engagedly fitted in each hole 33a so that the irradiation portion 32b faces the inside of the base member 33, whereby the white LEDs 32 are arranged in a concave form. As the white LEDs 32 may be used LEDs for irradiating white light independently, or LEDs for irradiating white light while mixing R light, G light and B light with one another.

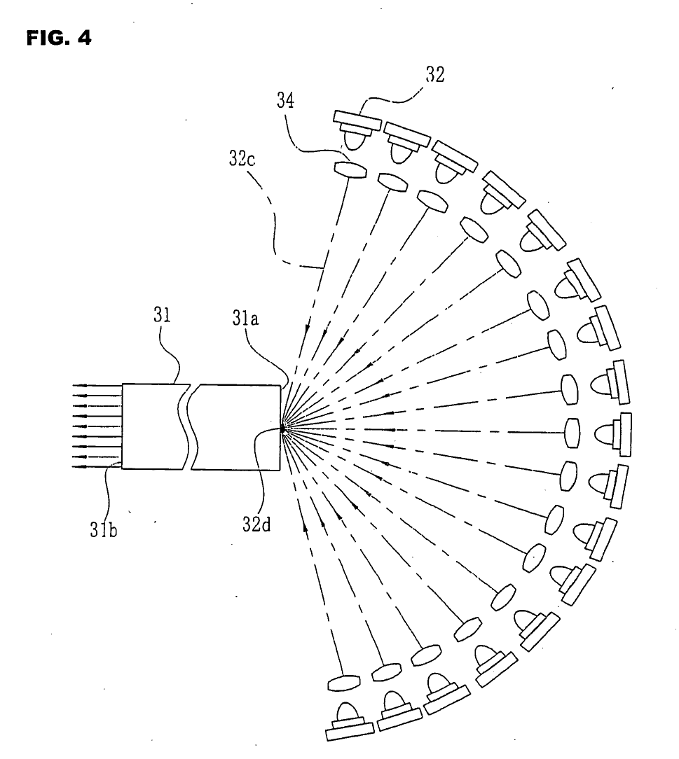

The plural condensing lenses 34 are fixed to the lens array 35 so as to be arranged in the same interval as the holes 33a. An opening portion 33b is formed on the flat surface of the base member 33 so as to intercommunicate with the hollow portion in the base member 33. The lens array 35 is inserted from the opening portion 33b and fixed in the base member 33. When the lens array 35 is fixed, each of the plural converging lenses 34 is located on the main illumination optical axis 32c (see FIG. 4) passing through the center of the illumination range of light emitted from each white LED 32. The heating amount of the while LEDs is set to a level that resin can be used as the material of the condensing lenses 34, and thus it is preferable that the condensing lenses 34 may be formed integrally with the lens array 35. Accordingly, even when the lens array 35 is designed in a complicated shape, the light source can be simply manufactured.

The rod integrator 31 is formed of transparent material to have a quadratic-prism shape. A surface of the rod integrator 31 which is located at one end side thereof in the longitudinal direction and faces the opening portion 33a serves as a light incidence face 31a to which light irradiated from white LEDs 32 is incident, and a surface of the rod integrator 31 which is located at the opposite side to the light incident face 31a serves as a light emission face 31b from which light incident from the light incident face 31a is irradiated to the outside.

As shown in FIG. 4, when illumination light is emitted from the white LEDs 32 under the state that the white LEDs 32 are fixed to the base member, the respective main illumination optical axes 32c of the white LEDs 32 cross one another substantially at one point. The rod integrator 31 is disposed in front of the base member 33 and so that the light incident face 31a is located in the neighborhood of the cross point 32d of the main illumination optical axes 32c. Therefore, the illumination lighs of the white LEDs 32 which are condensed by the condensing lenses 34 are incident to the light incident face 31a.

When the illumination lights irradiated from the white LEDs 32 are incident to the light incident face 31a, the respective incident illumination lights are mixed with one another by internal reflection, and then guided to the light emission face 31b, whereby the illumination light emitted from the light emission face 31b has substantially uniform intensity. The illumination light thus combined is emitted from the light emission face 31b, and guided to the illumination optical system 11.

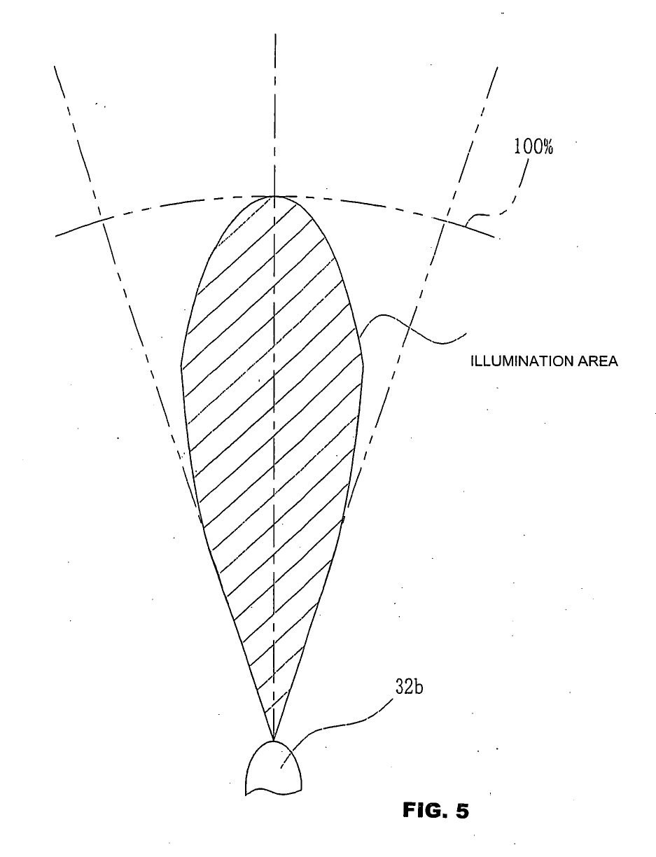

Here, as shown in FIG. 5, the light irradiated from the white LEDs 32 has a characteristic in that the brightness thereof is highest on the main irradiation optical axis 32c and it is gradually reduced toward the periphery of the light (a portion indicated by a broken line in the figure represents an intensity distribution of illumination light). Therefore, if the light irradiated from the white LEDs 32 is used without using any rod integrator 31, the image information on the screen 18 is bright at the center portion thereof and is gradually darkened toward the peripheral portion thereof. Accordingly, the liquid crystal projector 10 can achieve uniformly bright image information by using the rod integrator 31.

Suitable material such as glass, transparent resin such as acrylic resin or the like may be used as the material for the rod integrator 31 insofar as it is transparent material having a refractive index different from air. Furthermore, the shape of the rod integrator 31 is not limited to the quadratic prism, but it may be any suitable shape. It may be designed to have a hollow cylindrical shape. When the inside of the rod integrator 31 is designed to have a hollow portion therein, the light reflection frequency at the inner surface is increased, so that illumination light having more uniformly intensity can be achieved when illumination is irradiated from the irradiation face.

Next, the operation of the liquid crystal projector thus constructed will be described. When light is irradiated from the white LEDs 32, the light thus irradiated is condensed by the condensing lenses 34, and irradiated to the light incident face 31a of the rod integrator 31. At this time, the light incident face 31a is disposed in the neighborhood of the cross point 32d of the main irradiation optical axes 32c of the illumination lights emitted from the respective LEDs 32, and thus light having high brightness can be made incident to the light incident face 31a.

The lights incident from the light incident face 31a are mixed with one another by internal reflection in the rod integrator 31 and become light having substantially uniform intensity, and then the light concerned is irradiated from the light emission face 31b to the outside. Accordingly, the light irradiated from the white LEDs 32 is irradiated with substantially uniform brightness in a predetermined range while the irradiation direction thereof is varied. The illumination light irradiated from the rod integrator 31 is passed through the cross dichroic prism 16 and the projection lens 17 and then projected onto the screen 18.

In the above embodiment, only the white LEDs 32 for irradiating white light are provided to project image information. However, at least two kinds of LEDs which are different in light emission color may be provided. For example, in addition to the white LEDs 32, R light LEDs for irradiating R light may be provided in place of some of the white LEDs 32. In this case, color tone of image information to be projected can be corrected like addition of redness which is liable to be insufficient when only the white LEDs 32 are used. Furthermore, if LEDS for irradiating R light, G light and B light are provided and the colors of illumination light irradiated from these LEDs are switched to one another every predetermined time, the dichroic mirrors 13, 14 and the cross dichroic prism 16 may be omitted and only one liquid crystal panel may be used. Accordingly, the manufacturing cost of the liquid crystal projector can be reduced.

In the above embodiment, the condensing lenses 34 are arranged on the main irradiation optical axes 32c of the white LEDs 32 by using the lens array 35. However, the condensing lenses 34 may be fixed by any suitable method insofar as they are located on the main irradiation optical axes 32c of the white LEDs 32.

In the above embodiment, the base member 33 is designed in a semispherical shape. However, the shape of the base member may be set to a suitable shape, and any suitable method may be used as the method of fixing the while LEDs 32 insofar as the white LEDs 32 are arranged on the concave surface.

In the above embodiment, the present invention is not limited to the transmission type liquid crystal projector 10 in which light irradiated to the liquid crystal panel is transmitted, but it may be applied to a reflection type liquid crystal projector in which light irradiated to the liquid crystal panel is reflected, a projector using DMD or other projectors.

1. A light source device for illumination comprising:
plural light emitting diodes arranged in a concave shape so that respective main illumination axes of the plural light emitting diodes cross one another substantially at one cross point; and
a light guide that has a light incidence face in a neighborhood of the cross point and guides illumination lights emitted from the plural light emitting diodes to an illumination optical system for image projection, the illumination lights being incident from the light incident face.

2. The illumination light source device according to claim 1, wherein a condensing lens is disposed on each of the main illumination axes of the plural light emitting diodes, and condenses the illumination light from each of the plural light emitting diodes to make the illumination light incident to the light incident face of the light guide.

3. The illumination light source device according to claim 1, wherein the light guide comprises a rod integrator that guides the respective illumination lights incident from the light incidence face to a light emission face while mixing the respective illumination lights by internal reflection.

4. The illumination light source device according to claim 1, wherein the plural light emitting diodes comprise a white light emitting diode that irradiates a white light.

5. The illumination light source device according to claim 1, wherein the plural light emitting diodes comprise at least two types of light emitting diodes which emit different color lights.
